(19) United States
(12) Patent Application Publication
(10) Pub. No.: US 2016/0078010 A1
(43) Pub. Date: Mar. 17, 2016

(54) Device And Method For Presenting Pictures

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventor: Huan HUANG, Beijing (CN)

(21) Appl. No.: 14/784,538

(22) PCT Filed: Mar. 19, 2014
(86) PCT No.: PCT/CN2014/073698

§ 371 Date: Oct. 14, 2015

(30) Foreign Application Priority Data
Apr. 15, 2013 (CN) 201310129741.5

(51) Int. Cl. G06F 17/22; H04L 29/08; G06F 17/21

(52) U.S. Cl. CPC G06F 17/2247; G06F 17/212; H04L 67/02; H04L 67/322

(57) ABSTRACT

Disclosed are a device and method for presenting pictures in a page. The device comprising :a block divider configured to divide a page into a plurality of blocks; a block registrar configured to register each block and to register pictures required to be presented with a delay in each block; a picture renderer configured to download unregistered pictures in said page by a browser; a block presenting determiner configured to determine whether or not to present said registered blocks, if yes, to download the registered pictures required to be presented with a delay in said registered blocks by the browser by said picture renderer; and a picture presenter configured to present pictures which are downloaded and are located in a current window of the browser. Since the browser might allocate network resources to download pictures required to be presented, the network resources can be used reasonably, and a loading speed of the page can be improved.

### TECHNICAL FIELD

The disclosure relates to the field of computer technology, particularly to a method and device for presenting pictures in a page.

### BACKGROUND ART

With the rapid progress of internet, website pages use more and more multimedia resources to enrich displaying effect of the pages, to attract users to browse.

However, during the process of loading a page, all the pictures in the page will be downloaded, and even pictures outside the visible area of the page will also be downloaded. Since the network resource at the user is limited, the speed of loading the page will be reduced if all the pictures in the page are downloaded, thereby influencing user's experience.

### SUMMARY OF THE INVENTION

In view of aforesaid problem, the present disclosure provides a method and device for presenting pictures in a page to overcome aforesaid problem or at least partly solve aforesaid problem.

According to one aspect of the present disclosure, a method for presenting pictures in a page is provided, comprising steps of: dividing a page into a plurality of blocks and registering each block; registering pictures required to be presented with a delay in each block; downloading unregistered pictures in the page by a browser; determining whether or not to present the registered blocks, and if yes, downloading the registered pictures required to be presented with a delay in the registered blocks by the browser; and presenting the downloaded pictures that are located in a current window of the browser.

Optionally, the step of registering pictures required to be presented with a delay in each block comprises: embedding address information of the pictures required to be presented with a delay into custom tag attribute of a picture tag.

Optionally, the step of determining whether or not to present the registered blocks comprises: determining whether or not the registered blocks are located in the current window of the browser.

Optionally, the step of determining whether or not to present the registered blocks comprises: determining whether or not the registered blocks are visible when a scroll bar in a window of the browser moves.

Optionally, said method for presenting pictures in a page further comprises: determining whether or not to present the registered blocks when content presented in the current window of the browser changes, and if yes, downloading the registered pictures required to be presented with a delay in the registered blocks.

Optionally, the step of downloading the registered pictures required to be presented with a delay in the registered blocks comprises: copying the address information of the pictures from the custom tag attribute of the picture tag to source address attribute of the picture tag, so that the browser can download the pictures based on content of the picture tag.

According to another aspect of the present disclosure, a device for presenting pictures in a page is provided, comprising: a block divider configured to divide a page into a plurality of blocks; a block registrar configured to register each block and to register pictures required to be presented with a delay in each block; a picture renderer configured to download unregistered pictures in the page by a browser; a block presenting determiner configured to determine whether or not to present the registered blocks, if yes, to download the registered pictures required to be presented with a delay in the registered blocks by the browser by the picture renderer; and a picture presenter configured to present pictures which are downloaded by the picture renderer and are located in a current window of the browser.

Optionally, the block registrar embeds address information of the pictures required to be presented with a delay in custom tag attribute of a picture tag.

Optionally, the block presenting determiner determines whether or not the registered blocks would be presented by determining whether or not the registered blocks are located in the current window of the browser.

Optionally, the block presenting determiner determines whether or not to present the registered blocks by determining whether or not the registered blocks are visible when a scroll bar in a window of the browser moves.

Optionally, the block presenting determiner is configured to determine whether or not to present the registered blocks when content presented in the current window of the browser changes, if yes, the picture renderer downloads the registered pictures required to be presented with a delay in the registered blocks.

Optionally, the picture renderer copies address information of the pictures from custom tag attribute of the picture tag into source address attribute of the picture tag, so that the browser can download the pictures based on content of the picture tag.

According to further another aspect of the present disclosure, a computer readable recording medium is provided in which a program for executing aforesaid method for presenting pictures in a page is recorded.

The method for presenting pictures in a page and device for presenting pictures in a page of the present disclosure divides the page into a plurality of blocks. The registered pictures and pictures required to be presented with a delay can be placed in the blocks. When the blocks are located in the visible area of the page, the registered pictures and pictures required to be presented with a delay in the blocks would be downloaded. If the blocks are in the invisible area all the time, pictures in the blocks would not be downloaded, thus the browser will allocate network resource to download pictures required to be presented, so that the network resource can be used reasonably, and the loading speed of the page can be improved.

Above description is only a summary of the technical scheme of the present disclosure. In order to make the technical means of the present disclosure clearer so that it can be put into effect according to the contents of the description, and to make the aforesaid and other purpose, features and advantages of the disclosure more apparent, the embodiments of the disclosure will be described in further detail with reference to the drawings.

### BRIEF DESCRIPTION OF THE DRAWINGS

By reading the detailed description of the preferred embodiments below, various other advantages and benefits become clear for a person skilled in the art. The drawings are only used for showing the preferred embodiments and are not intended to limit the present disclosure. And in the whole drawings, same reference signs are used for representing same components. In the drawings:

FIG. 1 is a flowchart showing a method 100 for presenting pictures in a page according to an embodiment of the disclosure;

FIG. 2 shows an exemplary page 200 for a browser according to an embodiment of the disclosure;

FIG. 3 is a structural diagram showing a device 300 for presenting pictures in a page according to an embodiment of the disclosure;

FIG. 4 is a diagram schematically showing a server for executing the method according to the present disclosure; and

FIG. 5 schematically shows a storage unit for holding or carrying program codes for executing the method according to the present disclosure.

### EMBODIMENTS OF THE INVENTION

The embodiments of the present disclosure are described in further detail with reference to the drawings below. Although the drawings show the embodiments of the present disclosure, it should be understood that the disclosure can be implemented in various forms and is not intended to be limited by the embodiments described here. On the contrary, the embodiments are provided to make the disclosure to be understood more thoroughly and completely convey the scope of the disclosure to a person skilled in the art.

Webpage runs in various browsers. The speed of browser downloading, analyzing, and rendering content of the webpage directly influences user's experience. Therefore, the present disclosure provides a method for presenting pictures in a page and a device for presenting pictures in a page. For the convenience of explanation, the plane of a window of the browser is set to XY plane in the description below.

The method for presenting pictures in a page provided by the present disclosure comprises dividing the page into a plurality of blocks, the registered pictures required to be presented with a delay can be placed in the blocks, and when the blocks are located in the visible area of the page, the registered pictures required to be presented with a delay in the blocks would be downloaded. If the blocks are in the invisible area all the time, pictures in the blocks would not be downloaded, at this time the browser would allocate network resource to download pictures required to be presented, so that the network resource can be used reasonably, and the loading speed of the page can be improved. The “visible area” here refers to the visible scope of the webpage, specifically to a part of the entire HTML page document that can be presented in a window of the browser. Generally the overall height of an HTML document is higher than the height of a window of the browser, thus a part of the page will be hidden, and a user can view the hidden area of the page by moving the scroll bar of the browser. During the whole process, the part that can be seen is called visible area of the page.

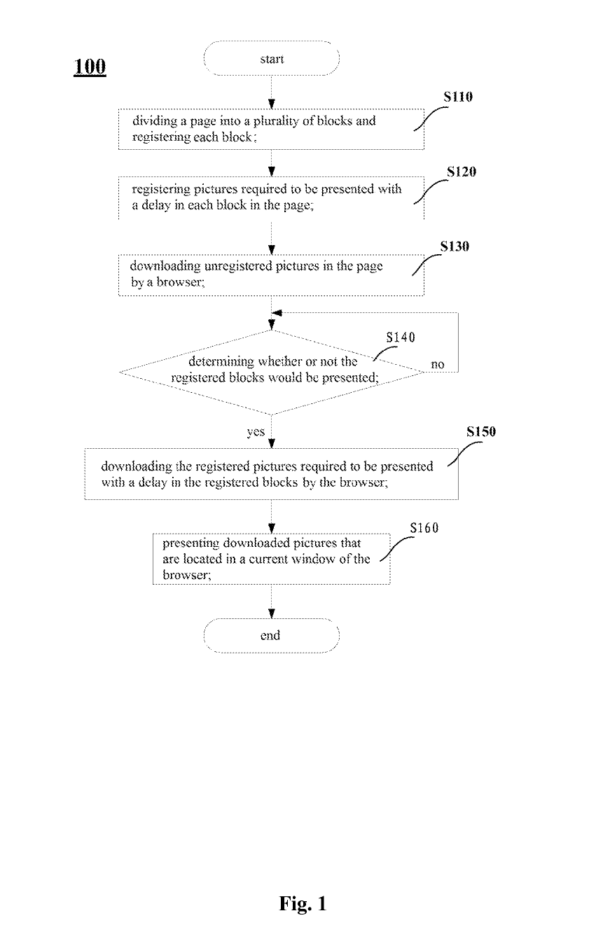

A flowchart showing a method 100 for presenting pictures in a page suitable for solving aforesaid problem according to an embodiment of the disclosure will be described in further detail with reference to FIG. 1.

As shown in FIG. 1, the method 100 for presenting pictures in a page according to an embodiment of the disclosure starts with Step S110. In Step S110, the page is divided into a plurality of blocks and the blocks are registered. Wherein, one or more pictures can be placed in each block, and the pictures can be static pictures or dynamic pictures. Different presenting modes of the pictures can be achieved by managing the pictures in the blocks, for example, some pictures can be presented directly without being registered, and some pictures need to be registered and then be determined when to be presented depending on conditions.

Optionally, the page can be divided into a plurality of blocks in the height direction of a window of the browser (i.e. direction of Y axis of a window of the browser), and parts of the implementing codes are as follows:

var mutex=$(body).getClientHeight( ); //height of a window of the browser;

var blocks=new Array($(body).scrollHeight( )/mutex); //dividing into a plurality of blocks and registering each block.

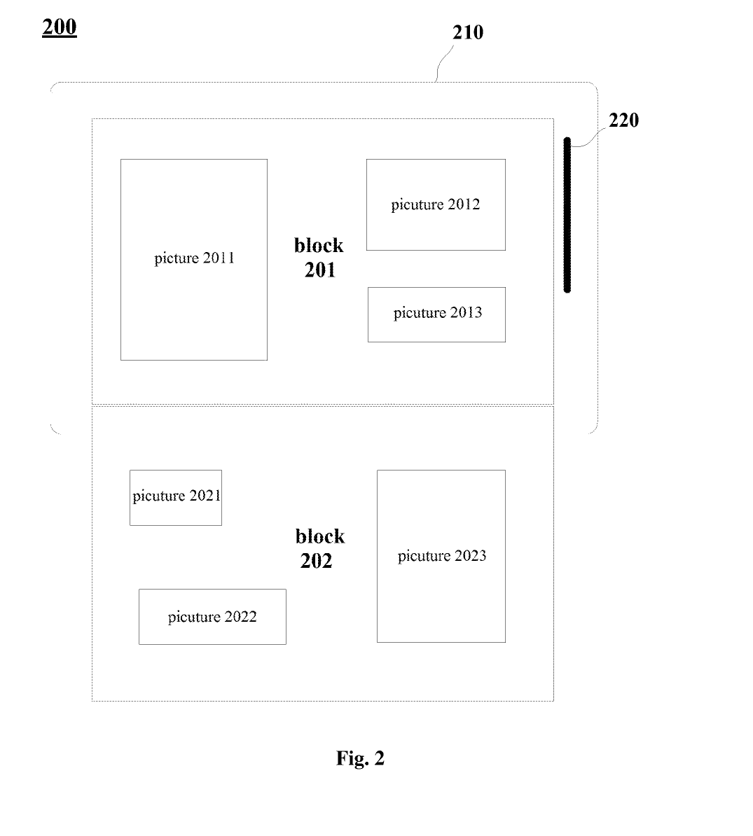

FIG. 2 shows an exemplary page 200 for a browser according to an embodiment of the disclosure. As shown in FIG. 2, a page 200 formed by an HTML document is divided into a plurality of blocks in the direction of Y axis of the browser, according to the height of a window of the browser 210. For the sake of clearness of the figure, only two blocks 201 and 202 are shown in FIG. 2, but actually several blocks can be included. In the course of presenting the page, a plurality of divided blocks can be recorded, for example, in the course of loading the page, the divided blocks can be registered by using the JavaScript run during loading the page. The block 201 contains three pictures 2011, 2012 and 2013, wherein picture 2011 is required to be presented with a delay, while pictures 2012 and 2013 need to be presented in real time. The block 202 contains three pictures 2021, 2022 and 2023, wherein pictures 2022 and 2023 are required to be presented with a delay, while picture 2021 needs to be presented in real time. Herein, the pictures required to be presented with a delay will be presented only when they are required to be presented, for example, when the blocks where they are located are in the current window of the browser, or when the blocks where they are located will be in the current window of the browser while the scroll bar of the browser moves.

FIG. 2 only shows an example with a scroll bar in the direction of Y axis. Optionally, when the width in the direction of X axis of the page is larger than the width of a window of the browser (i.e. size of a window of the browser in the direction of X axis), a plurality of blocks can be divided in the direction of X axis. The dividing mode is like aforesaid dividing mode in the direction of Y axis.

Then, in Step S120, pictures required to be presented with a delay in each block in the page are registered. That is, if there are pictures required to be presented with a delay in the block, the pictures required to be presented with a delay are registered.

Optionally, registering the pictures required to be presented with a delay refers to embedding address information of the pictures required to be presented with a delay into custom tag attribute of a picture tag, and parts of the implementing codes are as follows:

<img data-lazyload=“address of the pictures” width=“90” height=“64” alt“”/>

In the embodiment of the present disclosure, the picture tag of the pictures required to be presented with a delay (e.g. img tag) do not contain address information of the pictures, for example, there is no the part of “src=“address of the pictures”” or no value is assigned to src. However, the address information of the pictures required to be presented with a delay is embedded into custom tag attribute of the picture tag. For example, the custom tag attribute can be data-lazyload attribute. Thus when the page analyzes picture tag of a picture required to be presented with a delay, since the picture tag of the picture required to be presented with a delay has no crucial address information of the picture, the picture will not be presented in the page in real time, and the picture will be presented with a delay based on the custom tag attribute of the picture tag.

Subsequently, in Step S130, unregistered pictures in the page are downloaded by the browser.

Wherein, the process of downloading an unregistered picture in the page can be that the page analyzes the picture tag of the unregistered picture first, and when the picture tag contains the address information of the picture, the browser can download the picture in real time.

For example, in the page 200 shown in FIG. 2, the unregistered pictures 2012, 2013 and 2021 can be downloaded directly when the page 200 is displayed, that is to say, even if the blocks where the unregistered pictures are located are not in the current window of the browser, the pictures are downloaded and in the state of being presented at any time.

Subsequently, in Step S140, determine whether or not to present the registered blocks. Optionally, the determining whether or not to present a registered block can be made in following two modes: one mode is determining whether or not the block is located in the current window of the browser; the other mode is determining whether or not the block will be in the window of the browser by moving. For example, the block moves in the direction of Y axis of the browser, or the block moves in the direction of X axis of the browser.

Wherein, the blocks located in the current window of the browser refer to the blocks in the page displayed in the current window of the browser. Generally the overall height of a page formed by an HTML document is higher than the height of a window of the browser, thus a part of the page will be hidden, and the hidden part of the page can be viewed by moving the scroll bar of the browser.

See FIG. 2 again, the block 201 of the page 200 is located in the current window 210 of the browser, while the block 202 is not in the current window 210 of the browser, thus the block 201 is determined to be presented, and the block 202 is determined not to be presented. Optionally, if the block 202 can be presented via the scroll bar of the browser, then the block 202 is determined to be presented.

When a block is determined to be presented in Step S140, enter Step S150. In Step S150, the registered pictures required to be presented with a delay in the block are analyzed, rendered, and downloaded in the browser. Optionally, the address information of the pictures is copied from custom tag attribute of the picture tag to source address attribute of the picture tag, so that the browser can download the pictures based on content of the picture tag.

The process of Step S130 and Step S150 will be described in detail with reference to FIG. 1 and FIG. 2 below. In the method 100 for presenting pictures of the present disclosure, when presenting a page, downloading, analyzing, and rendering the unregistered pictures 2012, 2013 and 2021 in Step S130, then determining whether or not to present the registered blocks 201 and 202 in Step S140. When the block 201 is located in the current window of the browser, the blocks 201 is determined to be presented in real time. Then, in Step S150, downloading the content of the registered picture 2011 required to be presented with a delay in block 201, and analyzing and rendering to present the picture; in Step S140, since the block 202 is not located in the current window of the browser, the content of registered pictures 2022 and 2023 required to be presented with a delay in the block 202 need not be downloaded, and hence is not presented. When the content presented in the current window of the browser changes, for example, when the block presented in the current window becomes 202 by moving the scroll bar of the current window of the browser, return back to Step S140, and determining whether or not to present the registered blocks 201 and 202. At this time, it is determined that block 202 would be presented and block 201 would not be presented, thus the content of the pictures 2022 and 2023 in the block 202 required to be loaded with a delay need be downloaded, analyzed and rendered. The implementing codes of this part are as follows:

```
    //when move event or onload event happens, traversing the content
    of all registered blocks
    body.onload = body.onscroll = function( ){
    var currentHeight = body.getScrollHeight( );
    var currentBlock = currentHeight / mutex; //currently block
    if(!blocks[currentBlock]){ //if this block has not been loaded
    loadBlock(currentBlock);  //loading
    blocks[currentBlock] = true //set this block as having been loaded
    }
    //or waiting for another opportunity
    };
    function loadBlock(i){
    target_block = getTargetElement(i); //leave out a part of logic
    $(‘img[data-lazyload]’, target_block).each(function( ){
        var $this = $(this);
        $this.attr(‘src’, $this.data(‘ data-lazyload ’));
    //i.e. copy the value of the attribute “data-lazyload” of the picture to
the attribute “src”, so as to ensure that the browser engine can download
the picture data of the picture.
    });
    }
```

After downloading the registered pictures required to be presented with a delay in the registered blocks in Step S150, in Step S160, the downloaded pictures located in the current window of the browser are presented. The pictures here comprise the downloaded unregistered pictures and downloaded registered pictures.

What should be noticed is that the method shown in FIG. 1 does not define the sequence of aforesaid steps. The sequence of the steps can be adjusted as necessary, for example, Steps S140˜Step S160 can be executed before Step S130. In addition, said steps are not limited to aforesaid division of steps. Aforesaid steps can be further divided into more steps, or be merged into fewer steps.

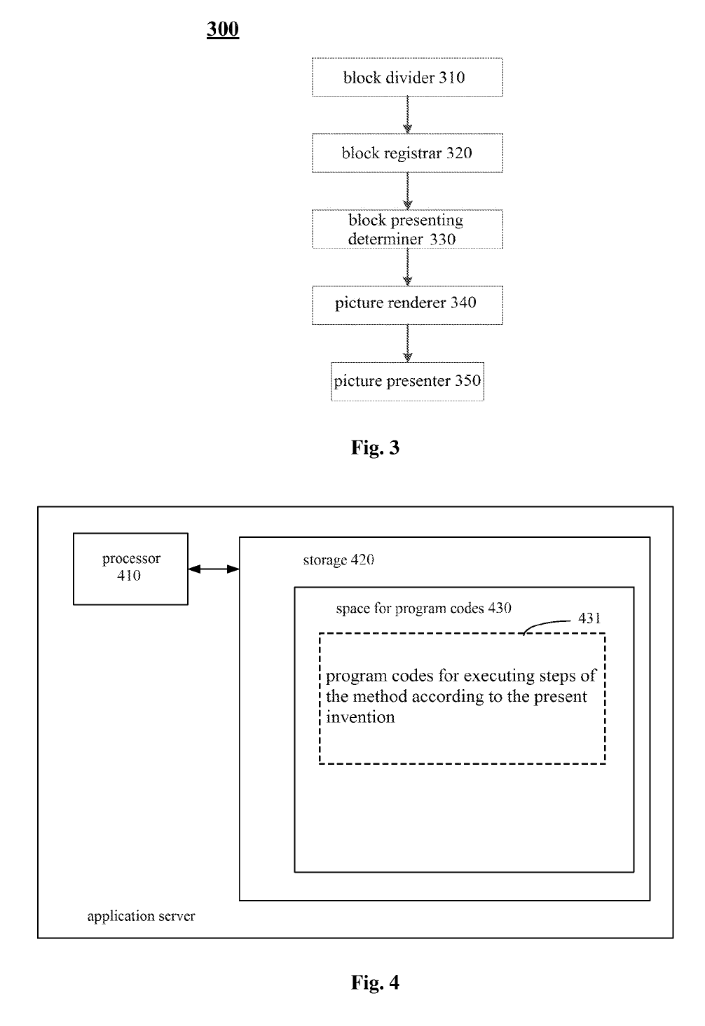

A device 300 or presenting pictures in a page suitable for solving aforesaid problem according to an embodiment of the disclosure will be described in further detail with reference to FIG. 3.

As shown in FIG. 3, the device 300 for presenting pictures in a page of the embodiment of the disclosure comprises: a block divider 310, a block registrar 320, a block presenting determiner 330, a picture renderer 340 and a picture presenter 350.

The block divider 310 is configured to divide a page into a plurality of blocks. Optionally, the block divider 310 can be configured to divide the page into a plurality of blocks in the height direction of a window of the browser, wherein, one or more pictures can be placed in each block, and the pictures can be static pictures or dynamic pictures. Different presenting modes of the pictures can be achieved by managing the pictures in the blocks, for example, some pictures can be presented directly without being registered, and some pictures need to be registered and then to be determined when to be presented depending on conditions. Optionally, the page can be divided into a plurality of blocks in the height direction of a window of the browser (i.e. direction of Y axis of a window of the browser). For example, as shown in FIG. 2, a page 200 formed by an HTML document is divided into a plurality of blocks in the direction of Y axis of the browser based on the height of a window of the browser 210. For the sake of clearness of the figure, only two blocks 201 and 202 are shown in FIG. 2, but actually several blocks can be included. In the course of presenting the page, a plurality of divided blocks can be recorded. For example, in the course of loading the page, the divided blocks can be registered by using the JavaScript run during loading the page. The block 201 contains three pictures 2011, 2012 and 2013, wherein picture 2011 is required to be presented with a delay, while pictures 2012 and 2013 need to be presented in real time. The block 202 contains three pictures 2021, 2022 and 2023, wherein pictures 2022 and 2023 are required to be presented with a delay, while picture 2021 needs to be presented in real time.

The block registrar 320 registers each block divided by the block divider 310 and registers the pictures required to be presented with a delay in each block. For example, for the page 200 shown in FIG. 2, the pictures 2011, 2022 and 2023 required to be presented with a delay would be registered.

Optionally, the block registrar 320 embeds address information of the pictures required to be presented with a delay in custom tag attribute of picture tag, for example, parts of the implementing codes are as follows:

<img data-lazyload=“address information of the pictures” width=“90” height=“64” alt=“”/>

In aforesaid codes, the picture tag img of the picture required to be presented with a delay does not contain address information of the picture (i.e. there is not the part of “src=“address of the pictures””). However, the address information of the picture required to be presented with a delay is embedded in custom tag attribute of the picture tag img. For example, the custom tag attribute can be data-lazyload attribute. Thus when the page analyzes picture tag of a picture required to be presented with a delay, since the picture tag of the picture required to be presented with a delay has no crucial address information of the picture, the picture will not be presented in the page in real time, and the picture will be presented with a delay based on the custom tag attribute of the picture tag.

The block presenting determiner 330 is configured to determine whether or not to present the registered blocks. Optionally, the block presenting determiner 330 determines whether or not the registered blocks are presented by determining whether or not the registered blocks are located in the current window of the browser; or, the block presenting determiner 330 determines whether or not to present by determining whether or not the registered blocks are visible when the scroll bar in a window of the browser moves.

The blocks located in the current window of the browser refer to the blocks displayed in the current window of the browser in the page. Generally the overall height of a page formed by an HTML document is higher than the height of a window of the browser, thus only a part of the page will be displayed in the current window of the browser and the other part would be in an invisible area, i.e. be hidden. And the part in the invisible area can be viewed by moving the scroll bar of the browser.

As the page 200 shown in FIG. 2, the block 201 is located in the current window 210 of the browser, while the block 202 is not in the current window 210 of the browser, thus the block 201 is determined to be presented, and the block 202 is determined not to be presented. Optionally, if the block 202 can be presented via the scroll bar of the browser, then the block 202 can be determined to be presented.

The picture renderer 340 is configured to download unregistered pictures in the page by a browser, and to download registered pictures required to be presented with a delay in the blocks determined by the block presenting determiner 330 to present by the browser. Wherein, the unregistered pictures in the page are directly analyzed, rendered, and downloaded in the browser, and then are presented, and the specific process can refer to the description of Step S130; the registered pictures required to be presented with a delay in the blocks determined by the block presenting determiner 330 to present cannot be directly downloaded and presented by the browser, since the picture tag img of the pictures required to be presented with a delay does not contain address information of the pictures or no value is assigned to src. At this time, the picture renderer 340 can copy the address information of the registered pictures required to be presented with a delay from custom tag attribute of the picture tag to source address attribute of the picture tag, so that the browser can download the pictures based on the address information of the picture tag. Here, analyzing, rendering and downloading the page can be the process of the browser displaying in the content of the page in a window of the browser according to the rules defined by HTML standard.

Optionally, the block presenting determiner 330 is further configured to determine whether or not to present aforesaid registered blocks when the content presented in the current window of the browser changes, if yes, downloading the registered pictures required to be presented with a delay in the registered blocks by the picture renderer 340.

The picture presenter 350 is configured to present pictures which are downloaded by the picture renderer 340 and are located in the current window of the browser, and the pictures here comprise the downloaded unregistered pictures and downloaded registered pictures.

According to the device of the present disclosure, when the content presented in the current window of the browser changes, said block presenting determiner determines whether or not to present said registered blocks. If yes, said picture renderer downloads the registered pictures that are required to be presented with a delay in said registered blocks.

According to the device of the present disclosure, said picture renderer copies the address information of the pictures from custom tag attribute of the picture tag to source address attribute of the picture tag, so that the browser can download said pictures according to the content of the picture tag.

The present disclosure also provides a computer readable recording medium where a program for executing aforesaid method for presenting pictures in a page is recorded. Said computer readable recording medium comprises any mechanism used for storing or transferring information in a form that can be read by computer. For example, machine readable medium comprises Read Only Memory (ROM), Random Access Memory (RAM), disk storage medium, optical storage medium, flash storage medium, electricity, light, sound or other forms of transmitting signals (e.g. carrier waves, an infrared signal, a digital signal, etc.).

The algorithms and displays are not inherently related with any designated computer, virtual system or other equipments. Various general-purpose systems can be used together with teachings based thereon. On the basis of the foregoing description, it is obvious to construct a structure demanded by this kind of system. In addition, the present disclosure does not direct at any designated programming language. It should be understood that various programming languages can be used for implementing the content of the disclosure described here, and that the forgoing description of a specific language is for disclosing the preferred embodiment of the disclosure.

The description provided here has illustrated a lot of specific details. However, it should be understood that the embodiments of the disclosure can be implemented without these specific details. In some embodiments, the well known methods, structures and techniques are not presented in detail, so that the description will not be obscure to understand.

Similarly, it should be understood that in order to simplify the present disclosure and help to understand one or more of the various aspects of the disclosure, the various features of the disclosure are sometimes grouped into a single embodiment, drawing, or description thereof. However, the method disclosed should not be explained as reflecting the following intention: i.e. the present disclosure sought for protection claims more features than the features clearly recorded in every claim. To be more precise, as is reflected in the following claims, the aspects of the disclosure is less than all the features of a single embodiment disclosed before. Therefore, the claims complying with a specific embodiment are explicitly incorporated into the specific embodiment thereby, wherein every claim itself acts as an independent embodiment of the disclosure.

A person skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and drawings) and any method or all process of the device or unit disclosed as such. Unless there is otherwise explicit statement, every feature disclosed by the present description (including the attached claims, abstract and drawings) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the present disclosure and forming different embodiments. For example, in the following claims, any one of the embodiments sought for protection can be used in various combination modes.

The various components embodiments of the present disclosure can be implemented by hardware, or implemented by software modules running on one or more processors, or implemented by combination thereof. A person skilled in the art should understand that microprocessor or digital signal processor (DSP) can be used for implementing some or all functions of some or all components of the devices for displaying the relevant information of the website accessed according to the embodiments in the present disclosure in practice. The present disclosure can also realize one part of or all devices or programs (for example, computer programs and computer program products) used for carrying out the method described here. Such programs for implementing the present disclosure can be stored in computer readable medium, or can possess one or more forms of signal. Such signals can be downloaded from the Internet website or be provided on carrier signals, or be provided in any other form.

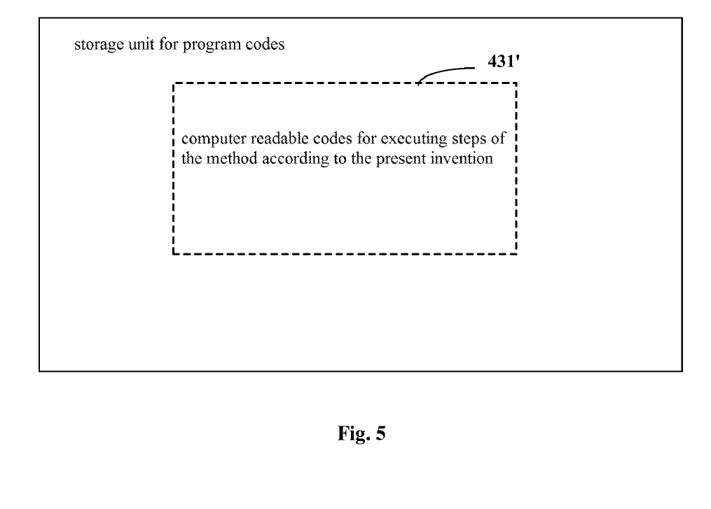

For example, FIG. 4 shows a server for achieving the method for presenting pictures according to the disclosure, for example, application server. The application server traditionally comprises processor 410 and computer program product in the form of storage 420 or computer readable medium. Storage 420 can be electronic storage such as flash memory, Electrically Erasable Programmable Read-Only Memory (EEPROM), EPROM, hard disk or ROM and the like. Storage 420 possesses storage space 430 for program codes 431 for carrying out of any step of aforesaid method. For example, storage space 430 for program codes can comprise each program code 431 used for implementing any step of aforesaid method. These program codes can be read out from one or more computer program products or write in one or more computer program products. The computer program products comprise program codes carrier such as hard disk, Compact Disc (CD), memory card or floppy disk and the like. These computer program products usually are portable or fixed storage cell as said in FIG. 5. The storage cell can possess memory paragraph, storage space like the storage 420 in the server of FIG. 4. The program codes can, for example, be compressed in a proper form. Generally, storage cell comprises computer readable code 431′, i.e. the code can be read by processors such as 410 and the like. When the codes run on a server, the server will carry out each step of the method described above.

It should be noticed that the forgoing embodiments are intended to illustrate the present disclosure and are not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The present disclosure can be implemented by means of hardware comprising several different elements and by means of properly programmed computer. In the unit claims listing several devices, several of the devices can be embodied by a same hardware item. The use of words “first”, “second” and “third ” does not mean any sequence. These words can be explained as name.

1-6. (canceled)

7. A device for presenting pictures in a page, comprising:
one or more non-transitory computer readable medium configured to store computer-executable instruction;
at least one processor to execute a plurality of software modules configured to execute the computer-executable instruction to cause:
dividing a page into a plurality of blocks;
registering each block and registering pictures required to be presented with a delay in each block;
downloading unregistered pictures in said page by a browser;
determining whether or not to present said registered blocks, if yes, downloading the registered pictures required to be presented with a delay in said registered blocks by the browser; and
presenting pictures which are downloaded and are located in a current window of the browser.

8. The device according to claim 7, wherein the processor executes at least one of the software modules configured to execute the computer-executable instruction to cause: embedding address information of the pictures required to be presented with a delay into custom tag attribute of a picture tag.

9. The device according to claim 7, wherein the processor executes at least one of the software modules configured to execute the computer-executable instruction to cause: determining whether or not the registered blocks would be presented by determining whether or not the registered blocks are located in the current window of the browser.

10. The device according to claim 7, wherein the processor executes at least one of the software modules configured to execute the computer-executable instruction to cause: determining whether or not to present said registered blocks by determining whether or not said registered blocks are visible when a scroll bar in a window of the browser moves.

11. The device according to claim 7, wherein the processor executes at least one of the software modules configured to execute the computer-executable instruction to cause: determining whether or not to present said registered blocks when content presented in the current window of the browser changes, if yes, downloading the registered pictures required to be presented with a delay in said registered blocks.

12. The device according to claim 8, wherein the processor executes at least one of the software modules configured to execute the computer-executable instruction to cause: copying address information of the pictures from custom tag attribute of the picture tag into source address attribute of the picture tag, so that the browser can download said pictures based on content of the picture tag.

13. A computer readable recording medium having instructions stored thereon that, when executed by at least one processor, cause the at least one processor to perform operations for presenting pictures in a page, which comprises the steps of:
dividing a page into a plurality of blocks and registering each block;
registering pictures required to be presented with a delay in each block;
downloading unregistered pictures in said page by a browser;
determining whether or not to present said registered blocks, and if yes, downloading the registered pictures required to be presented with a delay in the registered blocks by the browser; and
presenting the downloaded pictures that are located in a current window of the browser.

14. A method for presenting pictures in a page, comprising:
dividing a page into a plurality of blocks and registering each block;
registering pictures required to be presented with a delay in each block;
downloading unregistered pictures in said page by a browser;
determining whether or not to present said registered blocks, and if yes, downloading the registered pictures required to be presented with a delay in the registered blocks by the browser; and
presenting the downloaded pictures that are located in a current window of the browser.

15. The method according to claim 14, wherein the registering pictures required to be presented with a delay in each block comprises:
embedding address information of the pictures required to be presented with a delay into custom tag attribute of a picture tag.

16. The method according to claim 14, wherein the determining whether or not to present said registered blocks comprises:
determining whether or not said registered blocks are located in the current window of the browser.

17. The method according to claim 14, wherein the determining whether or not to present said registered blocks comprises:
determining whether or not said registered blocks are visible when a scroll bar in a window of the browser moves.

18. The method according to claim 14, wherein said method further comprises:
determining whether or not to present said registered blocks when content presented in the current window of the browser changes, and if yes, downloading the registered pictures required to be presented with a delay in said registered blocks.

19. The method according to claim 15, wherein the downloading the registered pictures required to be presented with a delay in said registered blocks comprises:
copying the address information of the pictures from the custom tag attribute of the picture tag to source address attribute of the picture tag, so that the browser can download said pictures based on content of the picture tag.
